(19) United States
(12) Patent Application Publication
(10) Pub. No.: US 2005/0172824 A1
(43) Pub. Date: Aug. 11, 2005

(54) Holder for mixer attachment

(76) Inventor: Darrell R. Estep, Boise, ID (US)

Correspondence Address: ROBERT L. SHAVER;DYKAS, SHAVER & NIPPER, LLP, PO BOX 877, BOISE, ID, 83701-0877, US

(21) Appl. No.: 10/776,550

(22) Filed: Feb. 10, 2004

(51) Int. Cl. A47J 9/00

(52) U.S. Cl. 99/348

(57) ABSTRACT

The present invention is a holder for mixing attachments, including a base member. The base member has a top side, bottom side, and left and right sides. A number of guide dowels are connected to the base side of the base member, each guide dowel with a retaining pin positioned on a side of the dowel. The guide dowels are configured so that an electric mixer attachment may be positioned, one over each of the guide dowels.

### BACKGROUND OF THE INVENTION

1. Field of the Invention

The present invention relates to a holder for mixer attachments and more particularly pertains to providing a kitchen aid for storage of mixer attachments, in a vertical orientation, onto a mounted base member, with the storage unit being removable from the base member.

2. Background

The use of a kitchen utensil holder is known in prior art. More specifically, kitchen utensil holders heretofore devised and utilized for the purpose of storing kitchen utensils are known to consist basically of familiar, expected, and obvious structural configurations, not withstanding the myriad of designs encompassed by the crowded prior art, which has been developed for the fulfillment of countless objectives and requirements.

By way of example, U.S. Pat. No. 4,183,439 to Bell discloses a utensil and tool holder. U.S. Pat. No. 4,254,881 to Hard discloses an overhead kitchen utensil rack. U.S. Pat. Number Des. 285,647 to Sachs discloses a drop clamp suspension bracket or similar article. U.S. Pat. No. 4,753,406 to Kodama and Takami discloses a hangar for kitchen appliances. U.S. Pat. No. 4,852,930 to Agee discloses a utility decorator. U.S. Pat. No. 4,728,158 to D'Elia and DeVries discloses a modular rack storage system and its method of assembly. U.S. Pat. No. 4,739,885 to Noland discloses a permanently mounted base member utilizing spring tensioned retaining pins. U.S. Pat. No. 5,769,246 to Estep discloses a bracket along a base member and spring tensioned retaining pins.

While these devices fulfill their respective, particular objectives and requirements, the aforementioned patents do not describe a holder for mixer attachments that allows coated mixing attachments to be protected from marring or scratches that occur when stored in a drawer, by storing them separately on a mounting bar, which can be removed from its mount and placed on a countertop.

In this respect, the holder for the mixer attachments substantially departs from the conventional concepts and designs of the prior art and, in doing so, provides an apparatus primarily developed for the purpose of providing a kitchen aid for storage of mixer attachments onto a mounted base member. The unit is removable from the base member unit for placement on a countertop.

Therefore, it can be appreciated that there exists a continuing need for a new and improved holder for mixer attachments, which can be used for providing a kitchen aid for storage of mixer attachments removably attached to a mounting bracket. In this regard, the present invention substantially fulfills this need.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In view of the foregoing disadvantages inherent in the known types of kitchen utensil holders now present in the prior art, the present invention provides an improved holder for mixer attachments. As such, the general purpose of the present invention, which will be described subsequently in greater detail, is to provide a new and improved holder for mixer attachments and method that has all of the advantages of the prior art and none of the disadvantages.

To attain this, the present invention comprises of a generally elongated base member. The base member has a bottom side with rounded top side and left and right ends. Extending from the bottom, perpendicular to the base member on one side, is one or more insertion tabs. A plurality of guide dowels are included. Each guide dowel is rounded at one end and interconnected along the apex of the rounded base member. The connection point of the guide dowel is filled in with a reverse radius. Each guide dowel has a retaining pin positioned on its side. The retaining pins are mounted perpendicular to the guide dowel and parallel to each other. The neck portion of the mixer attachment has a keyed slot. When installed on the guide dowel and pin and rotated 90 degrees, the keyed slot of the mixer attachment engages the retaining pin creating a positive lock effect, thus holding the mixer attachment firmly on the guide dowel.

Additionally, a mounting bracket is provided. The bracket is a single cast piece. It is of a general rectangular shape. It includes one or more areas that are recessed to fit one or more insertion tabs on the mounting base member. When the mounting bracket is fastened to a flat surface, the recessed area creates a pocket against the area that it is fastened to. This mounting pocket is of the correct size and shape to easily, yet firmly, receive one or more insertion tabs. The insertion tab(s) is also of the correct size to allow the base member to sit upright on a flat surface without tipping or falling over, while holding all of the mixer attachments.

Additionally, the base member may include additional tabs that allow the base member to be placed flat on a countertop, from which position the mixer tools can be accessed.

There has thus been outlined, rather broadly, the more important features of the present invention so that the detailed description thereof that follows may be better understood and so that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may be readily utilized as a basis for the designing of other structures, methods, and systems for carrying out the several purposes of the present invention. It is important, therefore, that the claims be regarded as including such equivalent construction insofar as they do not depart from the spirit and scope of the present invention.

It is therefore an object of the present invention to provide a new and improved holder for mixer attachments that has all of the advantages and none of the disadvantages of the prior existing kitchen utensil holders. This providing of a new and improved design is by its very nature set forth to be easily manufactured and marketed. It is further an object if the present invention to provide a new and improved holder that is of durable, reliable, and safe constructions. By doing so, the present invention design features allow for a low cost of manufacture with regard to both materials and labor, and which accordingly is susceptible of low prices to the consuming public, thereby making such a holder economically available to the buying public.

These design objects, along with the various features of novelty that characterize the invention are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

The invention will be better understood and objects other than those set forth above will become apparent when consideration is given to the following detailed description thereof. Such description makes reference to the annexed drawings wherein:

The purpose of the foregoing abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective view of the holder for mixer attachments mounted on the underside of a cabinet.

FIG. 2 is a front view of the present invention with mixer attachments.

FIG. 3 is an end view of the base member and mounting bracket of the present invention.

FIG. 4 is an isometric view of the present invention from a lower perspective.

FIG. 5 is an isometric view of the present invention from an upper perspective.

FIG. 6 is and exploded view of the guide dowel and retaining pin, in operating proximity to the mixer attachment.

FIG. 7 is an isometric view of the underside of the mounting bracket.

### DESCRIPTION OF THE PREFERRED EMBODIMENT

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

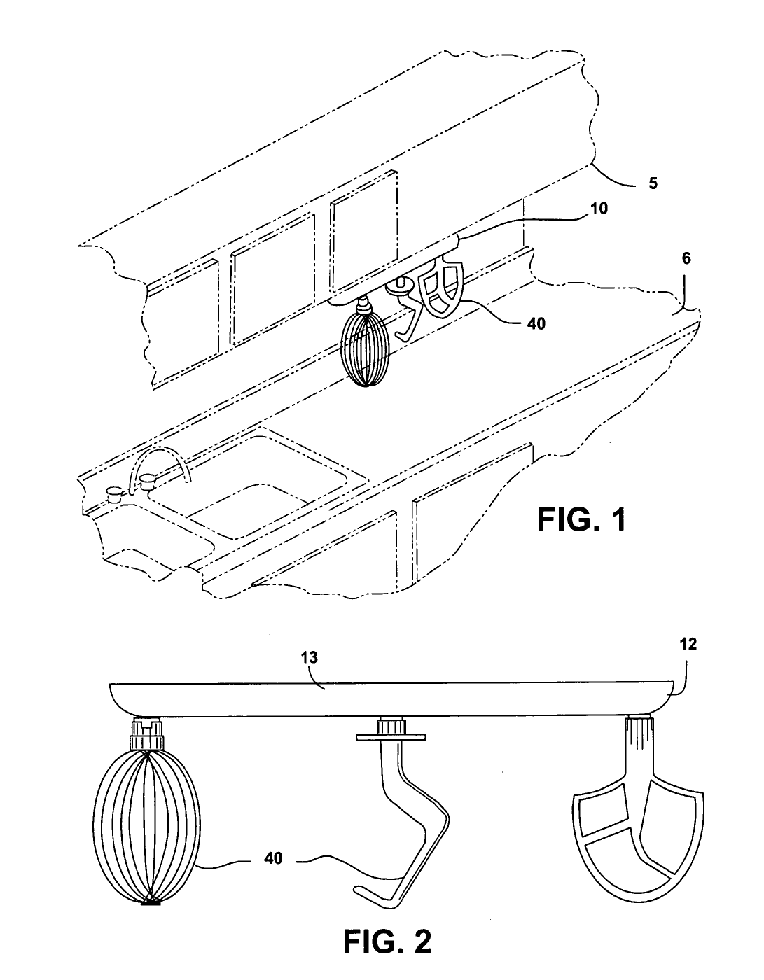

With reference now to the drawings, and in particular to FIG. 1, the preferred embodiment of the new and improved holder for mixer attachments embodying the principles and concepts of the present invention and generally designated by the reference number 10 will be described.

The present invention, a holder for mixer attachments, is designated as 10 and is comprised of a plurality of components. Such components in their broadest context include a base member with mounting tab, guide dowels, and a mounting bracket.

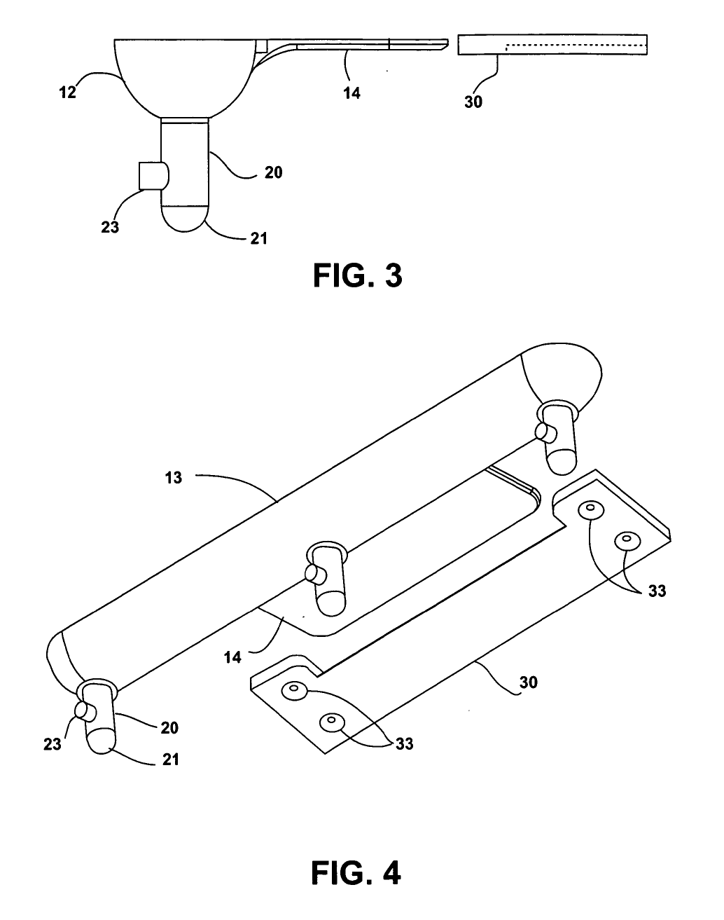

The present invention includes a generally elongate base member 12. The base member is rounded at each end and along the topside of its length. The base member is flat along the bottom side, with an insertion tab 14, which extends out on the same plane as the flat base member. The insertion tab(s), being approximately one-third of the length, is centered along the length and may be rounded on both sides and its end. The base member is preferably eleven and a half inches (11½″) long, one and a half inches (1½″) wide (not including the mounting tab), and one and a half inches (1½″) tall. The base member may be formed from wood, metal or plastic. In the present invention, plastic is the material of choice due to its weight and durability. Obviously, other materials are also possible and would fall within the scope of the claims. FIG. 2 shows a side view of the mixer attachments on the base member, as described above, while FIG. 3 shows an end view without attachments.

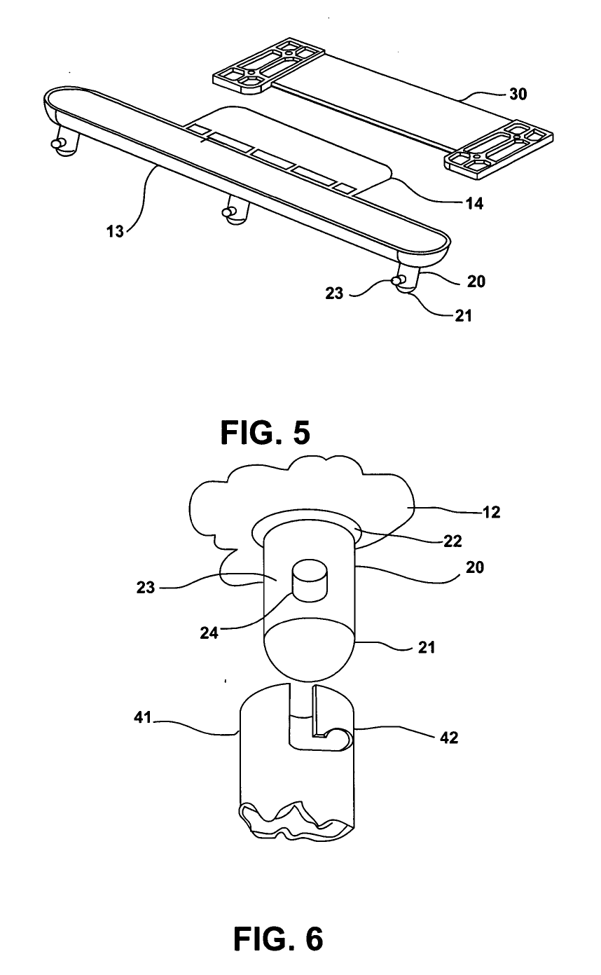

Included are a plurality of guide dowels 20. As shown in FIG. 4, each guide dowel may be rounded on one end 21 and interconnected to the apex of the rounded length of the base member 13 at the other end 22. The plurality of guide dowels is proportionately spaced in a symmetrical alignment along the base member. The spacing gap between any two of the plurality of guide dowels typically between two and a half to four and a half inches (2½-4½). This spacing gap is determined by the size of the mixer attachments and the space needed to easily install and remove them without interference from the adjacent attachment. The guide dowel diameter is such to create a slight friction fit within the bore of the mixer attachment. FIG. 5 shows the underside of the.

Each guide dowel has a retaining pin 23 positioned within a side 24 of the dowel. Each retaining pin is mounted parallel to the base member, yet perpendicular to the base member's length. The retaining pin is spaced on the guide dowel in such a way as to allow installation of the mixer attachment without interference with the base member. The retaining pin is of the correct length to engage the mixer attachment without being too long as to interfere with its installation or removal.

Additionally, at least one electric mixer attachment 40 is able to be positioned over one of the guide dowels 20. The mixer attachment may be a flat beater, dough hook or wire whip. The mixer attachment has a neck portion 41 with a keyed slot 42. The neck portion slides over any one of the guide dowels and the keyed slot engages the retaining pin on the dowel.

In operation, the neck of the mixer attachment is slid into the guide dowel with the keyed slot receiving the retaining pin. Once the retaining pin 23 is in the bottom of the keyed slot 42, the mixer attachment is rotated ninety degrees to lock the attachment onto the guide dowel, as seen in FIG. 2. The preferred embodiment of the present invention is structured to support up to three mixer attachments of any assortment, in any order. Other designs could support four or more attachments.

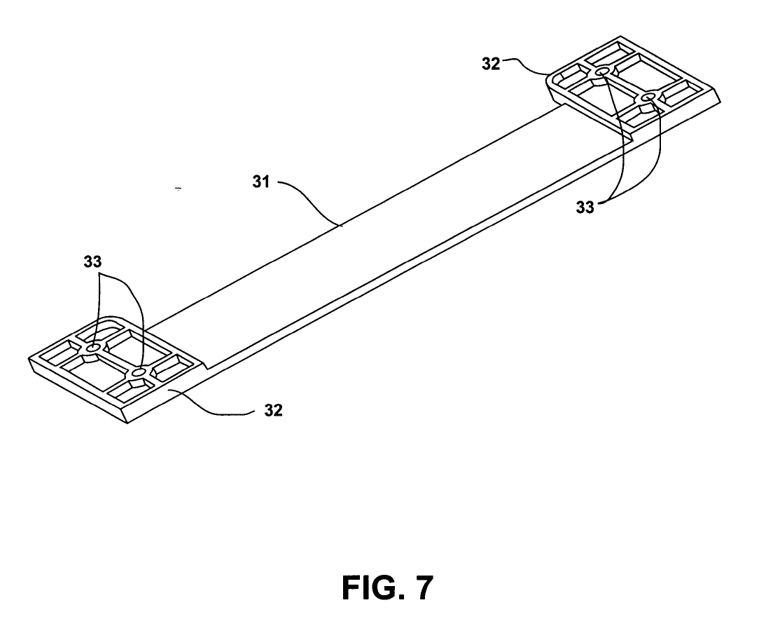

As shown in FIG. 7, mounting bracket 30 is provided. The bracket in this version is a single rectangular panel, with a raised area at each end of its length 32. The center section of the panel 31, being thinner than the raised areas 32, is of the same dimension as the tab 14 on the base member 12. The raised areas at each end have holes 33 in them to facilitate mounting to a flat surface 72 with a screw or other similar fastener. As shown in FIG. 1, the receiving structure is a kitchen cabinet or shelf. It is to be understood that the bracket is so designed as to be able to mount to any flat surface, which can include vertical surfaces. When the bracket is securely fastened to a flat surface, the center section of said bracket 31 creates a pocket in conjuncture with the adjoining surface. This pocket allows the insertion tab of the base member 14 to be inserted and removed easily. The dimensions are such to create a slight friction fit so the base member 12 cannot be accidentally knocked out of the mounting bracket.

The present invention is designed to provide storage for kitchen mixers attachments. The holder prevents damage to mixer attachments due to incorrect storage. The holder can be mounted beneath a cabinet, on a wall beneath a shelf, or allowed to stand upright on a counter top 6, with the bracket one or more insertion tabs acting as a stabilizing foot 14.

The base member may include additional tabs that aid in stabilizing the base member when it is removed from its attachment to the underside of the counter, and placed in an inverted position on a counter. The base member is specifically designed to be placed in this inverted position, to make the mixer attachments available from the countertop. In this configuration, the base unit may also be carried to another part of the kitchen, where the mixer may be in operation.

Although the description of the preferred embodiment above shows that the mounting bracket includes a centrally located recess for receiving the insertion tab of the base member. The concept of the invention also includes other configurations of this recessed area in the mounting bracket and the insertion tab on the base member. This could include a mounting bracket that is generally U-shaped, and which has recessed regions under the tips of the two U portions. Insertion tabs on the base bracket would thus slide under the recesses provided by such a U-shaped mounting bracket. Other configurations of insertion tabs and mounting bracket recesses could include insertion tabs on each end of the base member, which would slide into a two piece mounting bracket or a U-shaped mounting bracket with recessed mounting areas under all or parts of the arms of the U of the mounting bracket. Similarly, the base member could have one insertion tab that ran around three sides of the base member, which would be inserted into a one or two piece mounting bracket with a corresponding recess. Additionally, the mounting bracket could have two insertion tabs extending from the right side, which would interfit with a mounting bracket that had two recessed areas corresponding to the insertion tabs of the mounting of the base member.

A generally rectangular base member having a uniform structure and an integral mounting tab extending from the center for hanging in the mounting bracket or acting as a stabilizer when sitting upright on a horizontal surface. A plurality of guide dowels with each being rounded at one end and interconnected symmetrically along the apex of the rounded base member, being spaced proportionately about two and a half to four and a half inches (2½-4½) apart. Each guide dowel being of the proper diameter to create a slight friction fit against the interior bore of the receiving mixer attachment. Each guide dowel having a retaining pin positioned within its side perpendicular to the guide dowel and parallel to the flat side of the base member. At least one mixer attachment is able to be positioned over the guide dowels, the mixer attachment having a neck portion with a keyed slot being capable of engaging the retaining pin of the guide dowel and being rotated ninety degrees, thus locking onto the retaining pin. A mounting bracket having a generally rectangular shape, with raised ends and a recessed area in the center; which when mounted to a flat surface is capable of receiving the mounting tab of the base member with a slight friction fit. The raised ends having holes to allow a fastener to secure the mounting bracket to a horizontal flat surface in a semi-permanent manner. FIG. 6 shows details of the connection of an attachment to the guide dowel.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered an illustration only of the principles of the invention. Further, since numerous modifications and changes will readily occur to those skilled in the art, it is not desired to limit the invention to the exact construction and operation shown and described. Accordingly, all suitable modifications and equivalents may be resorted to falling within the scope of the invention.

What is claimed to be new and desired to be protected by Letters of Patent of the United States is as follows. A new and improved holder for mixer attachments for supporting an attachment in a vertical orientation comprising in combination:

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. An attachment holder, for use with mixing appliance attachments, each attachment including an attachment tool, a shaft with a bore attached to said tool, and an L shaped slot in said shaft, the attachment holder comprising:
a base member with a top side and a bottom side, and a left end and a right end, configured for removable mounting adjacent to an underside of a flat surface;
a plurality of guide dowels attached to said top side of said base member, each post configured for a friction fit with an attachment shaft, and a retaining pin for interfitting engagement with said L shaped slot on said attachment;
at least one generally flat insertion tab attached to said base member adjacent to said bottom side, and parallel to said bottom side, for removable engagement with a mounting bracket, and for use as a stabilizer when said base member is removed from said mounting bracket and placed in an inverted position on a counter;
said mounting bracket being configured for mounting to the underside of a cabinet, and for sliding engagement with said generally flat insertion tab, and including at least one slot for engagement of said at least one insertion tab of said base member.

2. The attachment holder of claim 1, in which said guide dowels are configured for a friction fit with said attachment shaft, in addition to the interfitting engagement with the L shaped slot on the attachment.

3. The attachment holder of claim 1, which further includes at least one generally flat base plate attached to said base member adjacent to said bottom side.

4. The attachment holder of claim 3 which said base plate is configured for use as a stabilizer when said base member is removed from said mounting bracket and placed in an upright position on a countertop.

5. An attachment holder, for use with mixing appliance attachments, each attachment including a shaft with a bore, and an L shaped slot, the attachment holder comprising:
a base member with a top side and a bottom side, and a left end and a right end, configured for mounting adjacent
a plurality of guide dowels attached to said top side of said base member, each post configured for a friction fit with an attachment shaft, and a retaining pin for interfitting engagement with said L shaped slot on said attachment;
a generally flat base plate attached to said base member adjacent to said bottom side, and parallel to said bottom side, for removable engagement with a mounting bracket, and for use as a stabilizer when said base member is removed from said mounting bracket and placed in an inverted position on a counter; and
said mounting bracket being configured for mounting to the underside of a cabinet, and for sliding engagement with said generally flat base plate.

6. The attachment holder of claim 5 in which said mounting bracket is generally U shaped, with a bracket spine with a first end and a second end, with a left mounting pad attached to said first end, and a right mounting pad attached to said second end, with said mounting pads defining a space between them for insertion of said base plate of said base member.

7. The attachment holder of claim 6 in which said left and right mounting pads define one of more openings for mounting screws.
